(19) United States
(12) Patent Application Publication
(10) Pub. No.: US 2026/0341584 A1
(43) Pub. Date: Oct. 29, 2026

(54) INDUCTOR COMPONENT

(71) Applicant: Murata Manufacturing Co., Ltd., Kyoto-fu (JP)

(72) Inventor: Yuuki KAWAKAMI, Nagaokakyo-shi (JP)

(73) Assignee: Murata Manufacturing Co., Ltd., Kyoto-fu (JP)

(21) Appl. No.: 19/669,749

(22) Filed: May 6, 2026

Related U.S. Application Data
(63) Continuation of application No. PCT/JP2024/022832, filed on Jun. 24, 2024.

(30) Foreign Application Priority Data
Nov. 9, 2023 (JP) 2023-191591

(51) Int. Cl. H01F 27/32; H01F 27/28

(52) U.S. Cl. CPC H01F 27/323; H01F 27/2804; H01F 27/2809

(57) ABSTRACT

An inductor component includes an element body, a second interlayer insulation layer, and an inductor conductor. The element body has a first main surface and includes a magnetic material. The second interlayer insulation layer is planar and extends parallel to the first main surface. The inductor conductor is in contact with a surface of the second interlayer insulation layer parallel to the first main surface. A first positive direction is defined as a direction that is one of directions perpendicular to the first main surface and that is from the inductor conductor side toward the second interlayer insulation layer side, and a first negative direction is defined as a direction opposite to the first positive direction. An end surface is defined as a surface that is one of outer surfaces of the second interlayer insulation layer and that faces in a direction parallel to the first main surface.

### CROSS-REFERENCE TO RELATED APPLICATIONS

This application claims benefit of priority to International Patent Application No. PCT/JP2024/022832, filed Jun. 24, 2024, and to Japanese Patent Application No. 2023-191591, filed Nov. 9, 2023, the entire contents of each are incorporated herein by reference.

### BACKGROUND

### Technical Field

The present disclosure relates to an inductor component.

### Background Art

An inductor component described in Japanese U.S. Pat. No. 6,690,386 includes an element body, a first interlayer insulation layer, an inter-conductor insulation layer, a second interlayer insulation layer, and a coil. The element body has a rectangular-parallelepiped shape. The element body includes a magnetic material. The first interlayer insulation layer is located in the element body and extends parallel to a main surface of the element body. The inter-conductor insulation layer extends from the first interlayer insulation layer in a direction perpendicular to the main surface. In a cross-sectional view perpendicular to the main surface, the inter-conductor insulation layer includes a plurality of portions that are arranged with spaces therebetween. The second interlayer insulation layer is connected to the inter-conductor insulation layer on a side opposite from the first interlayer insulation layer with respect to the inter-conductor insulation layer. The second interlayer insulation layer is parallel to the first interlayer insulation layer. The coil is located in a region partitioned by the first interlayer insulation layer, the inter-conductor insulation layer, and the second interlayer insulation layer.

### SUMMARY

In the disclosure described in Japanese U.S. Pat. No. 6,690,386, the first interlayer insulation layer, the inter-conductor insulation layer, and the second interlayer insulation layer are located in the element body. If the volume of the inductor component is fixed, as the number of insulation layers included in the inductor component increases, the volume of the magnetic material in the element body may decrease.

Therefore, an inductor component according to an aspect of the present disclosure includes: an element body that has a main surface and includes a magnetic material; an interlayer insulation layer that is planar and extends parallel to the main surface in the element body; and an inductor conductor that is in contact with a surface of the interlayer insulation layer parallel to the main surface. When a positive direction is defined as a direction that is one of directions perpendicular to the main surface and that is from the inductor conductor side toward the interlayer insulation layer side, a negative direction is defined as a direction opposite to the positive direction, and an end surface is defined as a surface that is one of outer surfaces of the interlayer insulation layer and that faces in a direction parallel to the main surface, in a specific cross section perpendicular to a center line of the inductor conductor, an entirety of the end surface is an inclined surface facing in a direction parallel to the main surface and the negative direction or an inclined surface facing in a direction parallel to the main surface and the positive direction.

With the above configuration, an increase in the inductance of an inductor component can be expected.

### BRIEF DESCRIPTION OF THE DRAWINGS

FIG. 1 is a perspective view of an inductor component;

FIG. 2 is a transparent side view of the inductor component;

FIG. 3 is a transparent top view of the inductor component;

FIG. 4 is a cross-sectional view of the inductor component taken along line 4-4 in FIG. 3;

FIG. 5 is a partially enlarged cross-sectional view in a specific cross section;

FIG. 6 is an enlarged schematic view illustrating the vicinity of a surface of a first interlayer insulation layer in the specific cross section;

FIG. 7 illustrates a method of manufacturing the inductor component;

FIG. 8 illustrates the method of manufacturing the inductor component;

FIG. 9 illustrates the method of manufacturing the inductor component;

FIG. 10 illustrates the method of manufacturing the inductor component;

FIG. 11 illustrates the method of manufacturing the inductor component;

FIG. 12 illustrates the method of manufacturing the inductor component;

FIG. 13 illustrates the method of manufacturing the inductor component;

FIG. 14 illustrates the method of manufacturing the inductor component;

FIG. 15 illustrates the method of manufacturing the inductor component;

FIG. 16 illustrates the method of manufacturing the inductor component;

FIG. 17 illustrates the method of manufacturing the inductor component;

FIG. 18 illustrates the method of manufacturing the inductor component;

FIG. 19 illustrates the method of manufacturing the inductor component;

FIG. 20 illustrates the method of manufacturing the inductor component;

FIG. 21 illustrates the method of manufacturing the inductor component;

FIG. 22 illustrates the method of manufacturing the inductor component;

FIG. 23 illustrates the method of manufacturing the inductor component;

FIG. 24 is a cross-sectional view of an inductor component according to a modification; and

FIG. 25 is a partially enlarged cross-sectional view of the inductor component according to the modification in a specific cross section.

### DETAILED DESCRIPTION

Hereafter, an embodiment of an inductor component will be described with reference to the drawings. Constituent elements in the drawings may be enlarged for ease of understanding. Dimensional ratios of constituent elements may differ from actual ratios or differ between drawings.

### Overall Structure

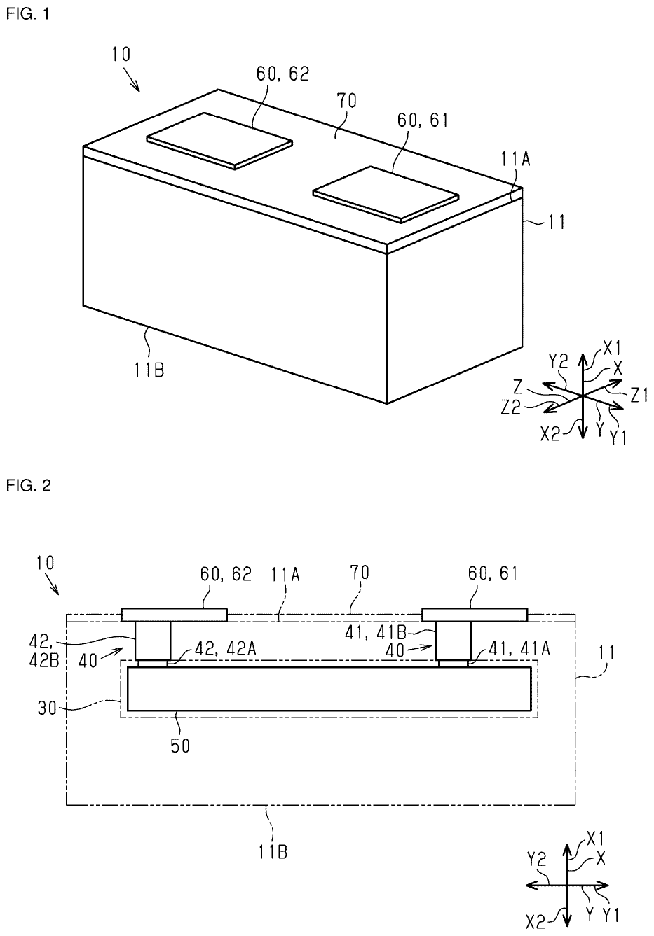

As illustrated in FIG. 1, an inductor component 10 has a substantially rectangular-parallelepiped shape as a whole. As illustrated in FIG. 2, the inductor component 10 includes an element body 11 and an inductor conductor 50.

As illustrated in FIG. 1, the element body 11 has six planar outer surfaces. A first main surface 11A is defined as a specific one of the six outer surfaces. A second main surface 11B is defined as a surface located opposite from the first main surface 11A and parallel to the first main surface 11A. The outer shape of the first main surface 11A and the outer shape of the second main surface 11B are each a rectangular shape. In the present embodiment, the first main surface 11A is a mounting surface that faces a substrate when the inductor component 10 is mounted on the substrate.

Here, a first axis X is defined as an axis perpendicular to the first main surface 11A. A second axis Y is defined as an axis perpendicular to the first axis X and parallel to a specific side of the first main surface 11A, which is a long side of the first main surface 11A in the present embodiment. A third axis Z is defined as an axis perpendicular to the first axis X and the second axis Y. A first positive direction X1 is defined as one of the directions along the first axis X in which the first main surface 11A faces, and a first negative direction X2 is defined as a direction opposite to the first positive direction X1. A second positive direction Y1 is defined as a specific one of the directions along the second axis Y, and a second negative direction Y2 is defined as a direction opposite to the second positive direction Y1. A third positive direction Z1 is defined as a specific one of the directions along the third axis Z, and a third negative direction Z2 is defined as a direction opposite to the third positive direction Z1.

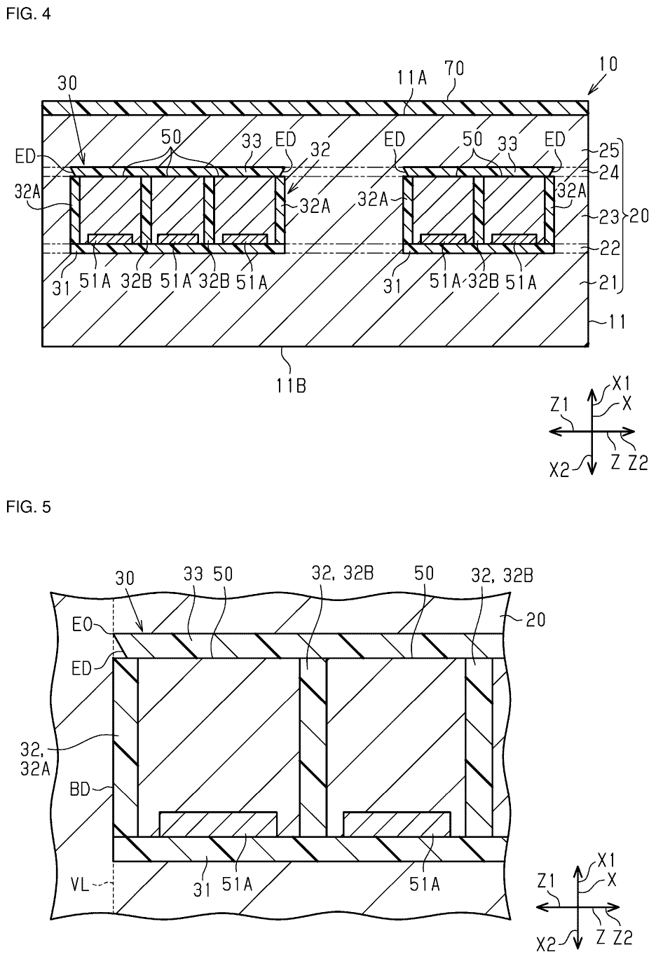

As illustrated in FIG. 4, the element body 11 includes, as magnetic layers 20, a first magnetic layer 21, a first interlayer magnetic layer 22, a second magnetic layer 23, a second interlayer magnetic layer 24, and a third magnetic layer 25, in order from the first negative direction X2 side. Although boundaries between the magnetic layers 20 are shown by two-dot chain lines in FIG. 4, these boundaries between the magnetic layers 20 might not be clearly observable. The material of the magnetic layers 20 is an organic resin containing metal magnetic powder. That is, the element body 11 includes a magnetic material. In the present embodiment, the metal magnetic powder is metal magnetic powder of an Fe-based alloy or an amorphous alloy. To be more specific, the metal magnetic powder is FeSiCr-based metal powder including iron. The metal magnetic powder is not limited to FeSiCr-based magnetic powder, and may be FeCo-based, FeSiAr-based, or iron-oxide-based magnetic powder, or a combination of these. The organic resin may be an epoxy-based, imide-based, liquid-crystal-polymer-based, acrylic-based, or phenol-based resin, or a combination of these. In the organic resin, inorganic fillers may be mixed with the above material.

As illustrated in FIG. 2, the inductor conductor 50 is located in the element body 11. As illustrated in FIG. 4, the inductor conductor 50 is located at the same position as the second magnetic layer 23 in a direction perpendicular to the first main surface 11A. The material of the inductor conductor 50 is an electroconductive material. In the present embodiment, the composition of the inductor conductor 50 is, for example, a composition such that the proportion of copper is greater than or equal to 99 wt % and the proportion of sulfur is greater than or equal to 0.1 wt % and less than or equal to 1.0 wt % (i.e., from 0.1 wt % to 1.0 wt %). The inductor conductor 50 is not limited to a conductor mainly composed of copper, and may be a conductor mainly composed of Ag, Al, or Au.

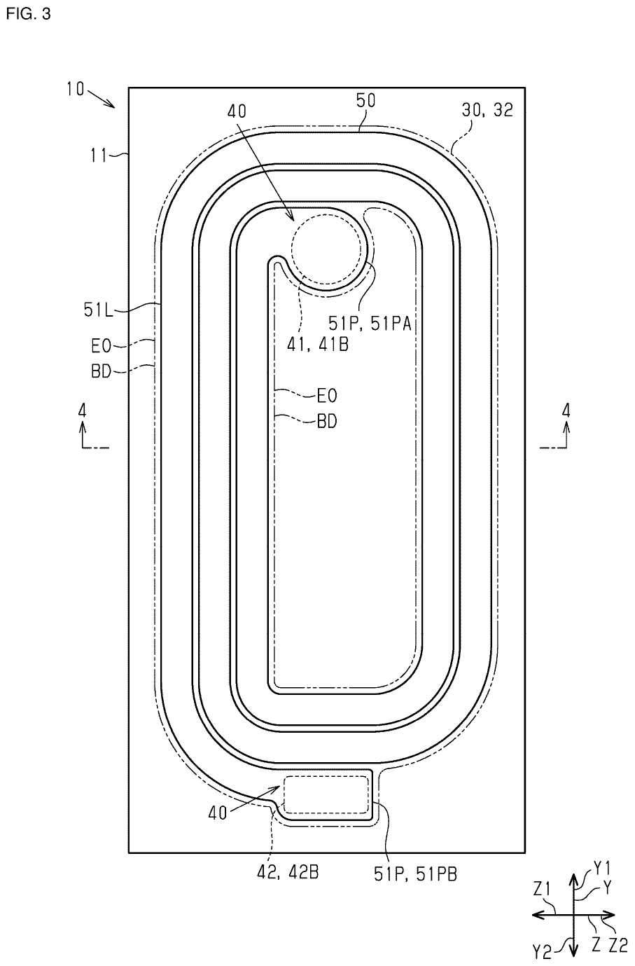

As illustrated in FIG. 3, the inductor conductor 50 extends parallel to the first main surface 11A and in a spiral shape. That is, the inductor conductor 50 is in the form of a line. As illustrated in FIG. 4, the inductor conductor 50 includes a seed layer 51A. The seed layer 51A constitutes a part of a surface of the inductor conductor 50 on the first negative direction X2 side. The material of the seed layer 51A is copper. As described below, by performing electrolytic copper plating on the seed layer 51A, copper grows on the seed layer 51A, and the entirety of the inductor conductor 50 is formed. In the process in which growth of copper plating is accelerated, a surface of the inductor conductor 50 on the first positive direction X1 side may become a curved surface that is convex toward the first positive direction X1 side.

As illustrated in FIG. 3, the inductor conductor 50 includes a pair of pad portions 51P and a conductor body 51L. The pair of pad portions 51P are located at both end portions of the inductor conductor 50. An inner pad portion 51PA is defined as one of the pair of pad portions 51P. An outer pad portion 51PB is defined as the other of the pair of pad portions 51P. In a see-through view in the first negative direction X2, the inner pad portion 51PA is located on the second positive direction Y1 side with respect to the geometric center of the element body 11. In a see-through view in the first negative direction X2, the inner pad portion 51PA has a substantially circular shape. In a see-through view in the first negative direction X2, the outer pad portion 51PB is located on the second negative direction Y2 side with respect to the geometric center of the element body 11. In a see-through view in the first negative direction X2, the outer pad portion 51PB has a substantially quadrangular shape.

The conductor body 51L connects the pair of pad portions 51P. To be specific, in a see-through view of the element body 11 in the first negative direction X2, the conductor body 51L extends counterclockwise from the inner pad portion 51PA toward the outer pad portion 51PB in such a way that the diameter thereof increases as the number of turns increases. The number of turns of the inductor conductor 50 is 2.5 turns.

The number of turns of the inductor conductor 50 is defined based on an imaginary vector. The initial point of the imaginary vector is disposed on the center line of the inductor conductor 50. The number of turns is defined to be 1.0 turn when the rotation angle of the orientation of the imaginary vector becomes 360 degrees while the initial point of the imaginary vector is moved from a first end to a second end of the center line in a see-through view in the first negative direction X2. In a case where the orientation of the imaginary vector rotates a plurality of times, it is defined that the number of turns increases when the orientation rotates successively in the same direction.

The center line of the inductor conductor 50 is defined as follows. In a see-through view in the first negative direction X2, a line segment that is the shortest of line segments that can be drawn from any point on an edge of the inductor conductor 50 to an edge on the opposite side is specified. The center line of the inductor conductor 50 is defined as a line connecting the centers of the specified line segments in a see-through view in the first negative direction X2.

As illustrated in FIG. 4, the inductor component 10 includes, as insulation layers 30, a first interlayer insulation layer 31, an inter-conductor insulation layer 32, and a second interlayer insulation layer 33.

The first interlayer insulation layer 31 is planar. The first interlayer insulation layer 31 extends in the element body 11 parallel to the first main surface 11A. The first interlayer insulation layer 31 is in contact with a surface of the first magnetic layer 21 on the first positive direction X1 side. The first interlayer insulation layer 31 is in contact with a surface of the inductor conductor 50 on the first negative direction X2 side. In other words, the inductor conductor 50 extends on the first positive direction X1 side with respect to the first interlayer insulation layer 31. Accordingly, the first interlayer insulation layer 31 is located at the same position as the first interlayer magnetic layer 22 in a direction perpendicular to the first main surface 11A.

The second interlayer insulation layer 33 is planar. The second interlayer insulation layer 33 extends in the element body 11 parallel to the first main surface 11A. The second interlayer insulation layer 33 is in contact with a surface of the inductor conductor 50 on the first positive direction X1 side. That is, the inductor conductor 50 is in contact with a surface of the second interlayer insulation layer 33 parallel to the first main surface 11A. However, a gap may be partially formed between the inductor conductor 50 and the second interlayer insulation layer 33. The first positive direction X1 is a direction that is one of the directions perpendicular to the first main surface 11A and that is from the inductor conductor 50 side toward the second interlayer insulation layer 33 side. The second interlayer insulation layer 33 is in contact with a surface of the third magnetic layer 25 on the first negative direction X2 side. Accordingly, the second interlayer insulation layer 33 is located at the same position as the second interlayer magnetic layer 24 in a direction perpendicular to the first main surface 11A.

When a side surface of the inductor conductor 50 is defined as a surface of the inductor conductor 50 facing in a direction parallel to the first main surface 11A, the inter-conductor insulation layer 32 covers the side surface of the inductor conductor 50. Accordingly, the inter-conductor insulation layer 32 includes a portion that is adjacent to the inductor conductor 50 in the direction parallel to the first main surface 11A. In the present embodiment, the entirety of the inter-conductor insulation layer 32 is adjacent to the inductor conductor 50 in the direction parallel to the first main surface 11A. The inter-conductor insulation layer 32 extends from the second interlayer insulation layer 33 in a direction perpendicular to the first main surface 11A, that is, the first negative direction X2. In other words, the inter-conductor insulation layer 32 extends from the first interlayer insulation layer 31 in the first positive direction X1. In a specific cross section perpendicular to the center line of the inductor conductor 50, the inter-conductor insulation layer 32 includes a plurality of portions that are discontinuous in a direction along the first main surface 11A. For example, in a specific cross section illustrated in FIG. 4, the inter-conductor insulation layer 32 includes seven portions that are discontinuous in the direction along the first main surface 11A. The specific cross section illustrated in FIG. 4 is a plane that passes through the geometric center of the element body 11 and that is perpendicular to the second axis Y.

Here, in the specific cross section, an outer insulation layer 32A is defined as a portion that is one of the portions of the inter-conductor insulation layer 32 and whose surface facing in a direction parallel to the first main surface 11A is in contact with the element body 11. In the specific cross section, an inner insulation layer 32B is defined as a portion that is one of the portions of the inter-conductor insulation layer 32 and whose surface facing in a direction parallel to the first main surface 11A is not in contact with the element body 11. For example, four outer insulation layers 32A are present in the specific cross section illustrated in FIG. 4. Three inner insulation layers 32B are present in the specific cross section. To be specific, in the specific cross section, two outer insulation layers 32A are located on the third positive direction Z1 side with respect to the geometric center of the element body 11, and two inner insulation layers 32B are located between the outer insulation layers 32A. The inductor conductor 50 is located between these portions of the inter-conductor insulation layer 32. Moreover, two outer insulation layers 32A are located on the third negative direction Z2 side with respect to the geometric center of the element body 11, and one inner insulation layer 32B is located between the outer insulation layers 32A. The inductor conductor 50 is located between these portions of the inter-conductor insulation layer 32. That is, the inductor conductor 50 is located in a region partitioned by these portions of the inter-conductor insulation layer 32.

As illustrated in FIG. 2, the inductor component 10 includes two columnar conductors 40 and two outer electrodes 60. Each columnar conductor 40 extends in a direction intersecting the first main surface 11A. In the present embodiment, each columnar conductor 40 extends in a direction perpendicular to the first main surface 11A. Each columnar conductor 40 is located on the first positive direction X1 side with respect to the inductor conductor 50. Each columnar conductor 40 is electrically connected to the inductor conductor 50.

To be specific, a first columnar conductor 41, which is one of the two columnar conductors 40, is composed of a first via 41A and a first extension conductor 41B. The material of the first columnar conductor 41 is the same as the material of the inductor conductor 50. The first via 41A has a substantially cylindrical shape. The first via 41A extends through the second interlayer insulation layer 33. That is, the first columnar conductor 41 extends through the second interlayer insulation layer 33. As a result, the first via 41A is located at the same position as the second interlayer insulation layer 33 and the second interlayer magnetic layer 24 in a direction perpendicular to the first main surface 11A. A surface of the first via 41A facing toward the first negative direction X2 side is connected to the inner pad portion 51PA of the inductor conductor 50.

As illustrated in FIG. 3, the first extension conductor 41B has a substantially cylindrical shape. As illustrated in FIG. 2, the diameter of the first extension conductor 41B is slightly larger than the diameter of the first via 41A. A surface of the first extension conductor 41B facing toward the first negative direction X2 side is connected to the first via 41A. Accordingly, the first extension conductor 41B is located at the same position as the third magnetic layer 25 in a direction perpendicular to the first main surface 11A. A surface of the first extension conductor 41B on the first positive direction X1 side is exposed from the first main surface 11A.

As illustrated in FIG. 2, a second columnar conductor 42, which is the other of the two columnar conductors 40, is composed of a second via 42A and a second extension conductor 42B. The material of the second columnar conductor 42 is the same as the material of the inductor conductor 50. The second columnar conductor 42 is located on the second negative direction Y2 side with respect to the first columnar conductor 41. The second via 42A has a substantially quadrangular prismatic shape. The second via 42A extends through the second interlayer insulation layer 33. That is, the second columnar conductor 42 extends through the second interlayer insulation layer 33. As a result, the second via 42A is located at the same position as the second interlayer insulation layer 33 and the second interlayer magnetic layer 24 in a direction perpendicular to the first main surface 11A. A surface of the second via 42A facing toward the first negative direction X2 side is connected to the outer pad portion 51PB of the inductor conductor 50.

As illustrated in FIG. 3, the second extension conductor 42B has a substantially quadrangular prismatic shape. As illustrated in FIG. 2, the dimension of each side of the second extension conductor 42B is slightly larger than the dimension of each side of the second via 42A. A surface of the second extension conductor 42B facing toward the first negative direction X2 side is connected to the second via 42A. Accordingly, the second extension conductor 42B is located at the same position as the third magnetic layer 25 in a direction perpendicular to the first main surface 11A. A surface of the second extension conductor 42B on the first positive direction X1 side is exposed from the first main surface 11A.

As illustrated in FIG. 1, each outer electrode 60 is exposed from the element body 11. To be specific, each outer electrode 60 is located on the first main surface 11A of the element body 11. That is, each outer electrode 60 covers a part of the outer surface of the element body 11.

As illustrated in FIG. 2, a first outer electrode 61, which is one of the two outer electrodes 60, is located, on the first main surface 11A, on the second positive direction Y1 side with respect to the geometric center of the first main surface 11A. The first outer electrode 61 is in contact with a surface of the first extension conductor 41B facing in the first positive direction X1. A second outer electrode 62, which is the other of the two outer electrodes 60, is located, on the first main surface 11A, on the second negative direction Y2 side with respect to the geometric center of the first main surface 11A. The second outer electrode 62 is in contact with a surface of the second extension conductor 42B facing in the first positive direction X1.

The inductor component 10 includes a solder resist 70. The solder resist 70 covers a portion of a surface of the element body 11 facing in the first positive direction X1 excluding the two outer electrodes 60. That is, the first main surface 11A of the element body 11 is covered by the outer electrodes 60 and the solder resist 70 and is not exposed. The solder resist 70 has higher insulation properties than the element body 11.

### Material of Insulation Layer

Hereafter, the materials of the first interlayer insulation layer 31 and the inter-conductor insulation layer 32 will be described. The material of the second interlayer insulation layer 33 is the same as that of the first interlayer insulation layer 31. Therefore, only the material of the first interlayer insulation layer 31 will be described.

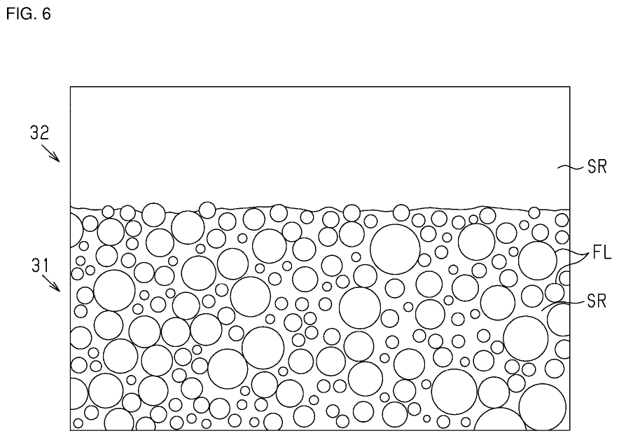

As illustrated in FIG. 6, the first interlayer insulation layer 31 includes a synthetic resin SR that is photocurable and a plurality of fillers FL that are dispersed in the synthetic resin SR. Here, “dispersed” means that the fillers FL are located randomly in the synthetic resin SR. Accordingly, even if some of the fillers FL are agglomerated, the fillers FL are said to be dispersed as long as the arrangement of the fillers FL is random as a whole. In FIG. 6, only some of the fillers FL are indicated by symbols.

In the present embodiment, the synthetic resin SR is an insulating resin. To be specific, the synthetic resin SR is a polyimide-based resin. The synthetic resin SR is a photocurable resin that is cured by ultraviolet rays. The volume percentage of the synthetic resin SR in the first interlayer insulation layer 31 is greater than or equal to 40 vol % and less than or equal to 70 vol % (i.e., from 40 vol % to 70 vol %). The volume percentage of the synthetic resin SR in the first interlayer insulation layer 31 is calculated, for example, as follows. First, by using a scanning electron microscope (SEM), a 500 nm square region in a cross section of the first interlayer insulation layer 31 is observed. In this region, the total area of portions where the fillers FL are not present, that is, the total area of the synthetic resin SR, is calculated by image processing. Then, an area percentage is calculated from the ratio of the total area of the synthetic resin SR to the area of the observed region. This step is repeated three times or more for different cross sections of the first interlayer insulation layer 31, and the area percentage for each region is calculated. Then, the average value of the calculated area percentages is calculated, and this calculation result is determined as the volume percentage.

The fillers FL are made of a nonmagnetic insulating inorganic compound. In the present embodiment, the fillers FL are made of silica. That is, in the present embodiment, the plurality of fillers FL are made of a nonmagnetic inorganic oxide.

The inter-conductor insulation layer 32 includes a synthetic resin SR having insulating properties and does not include the fillers FL. In the present embodiment, the material of the synthetic resin SR of the inter-conductor insulation layer 32 is the same as the material of the synthetic resin SR of the first interlayer insulation layer 31. That is, the material of the synthetic resin SR of the inter-conductor insulation layer 32 is a polyimide-based resin.

### Shape of Second Interlayer Insulation Layer

As illustrated in FIG. 5, an end surface ED is defined as one of the outer surfaces of the second interlayer insulation layer 33 facing in a direction parallel to the first main surface 11A. In the present embodiment, the entirety of the end surface ED is planar. As illustrated in FIG. 4, in the specific cross section, the second interlayer insulation layer 33 at one position has two end surfaces ED. As illustrated in FIG. 5, in the specific cross section, the entirety of the end surface ED is an inclined surface facing in a direction parallel to the first main surface 11A and the first negative direction X2. In the example illustrated in FIG. 5, the end surface ED faces in the third positive direction Z1 and the first negative direction X2. In this way, the end surface ED of the second interlayer insulation layer 33 is a surface that is inclined with respect to an imaginary axis perpendicular to the first main surface 11A. In FIG. 5, the imaginary axis coincides with a boundary BD. As long as the entirety of the end surface ED is an inclined surface facing in the aforementioned directions in a specific cross section perpendicular to the center line of the inductor conductor 50, the entirety of the end surface ED need not be an inclined surface facing in the aforementioned directions in a different cross section.

Here, in the specific cross section, an outermost edge EO is defined as the outermost edge of the end surface ED of the second interlayer insulation layer 33. In the present embodiment, the outermost edge EO is an outer edge of a surface of the second interlayer insulation layer 33 facing in the first positive direction X1. In other words, the outermost edge EO is an edge of the end surface ED on the first positive direction X1 side. An outer edge of the surface of the second interlayer insulation layer 33 facing in the first negative direction X2 is located inside with respect to the outermost edge EO. In other words, the entirety of the end surface ED of the second interlayer insulation layer 33 has a shape that is recessed with respect to the outermost edge EO.

As illustrated in FIG. 3, in a see-through view of the inductor component 10 in a direction perpendicular to the first main surface 11A, the outermost edge EO of the end surface ED is located on the boundary BD between the element body 11 and the outer insulation layer 32A. That is, as illustrated in FIG. 5, in a specific cross section, the outermost edge EO of the end surface ED of the second interlayer insulation layer 33 is located on an imaginary line VL that is an extension, in a direction perpendicular to the first main surface 11A, of the boundary BD between the element body 11 and the outer insulation layer 32A. In the present embodiment, an end of the end surface ED of the second interlayer insulation layer 33 on the first negative direction X2 side is located on a surface of the outer insulation layer 32A on the first positive direction X1 side.

### Manufacturing Method

Next, a method of manufacturing the inductor component 10 will be described.

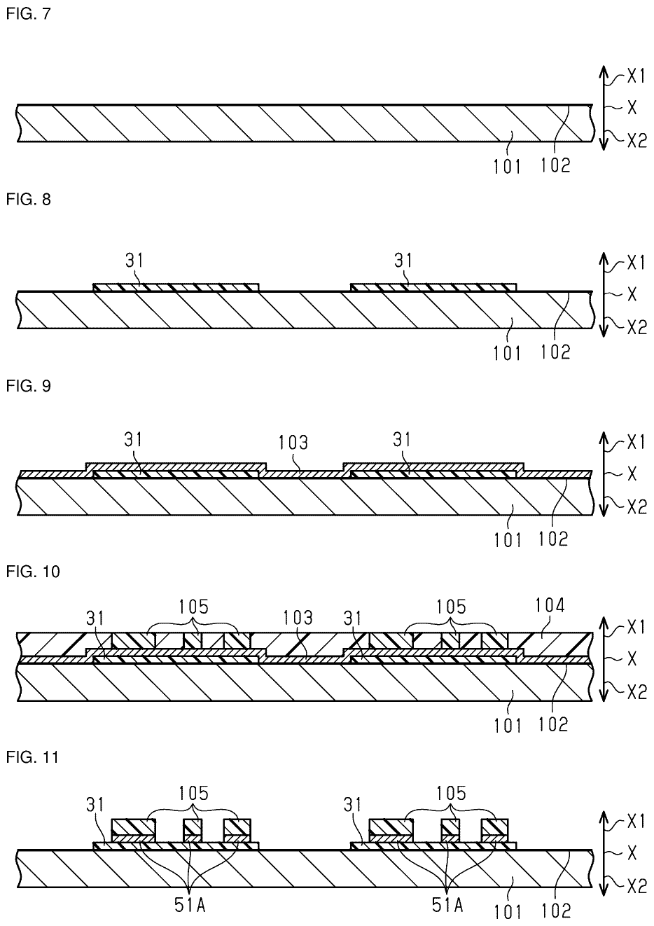

As illustrated in FIG. 7, first, a base preparing step is performed. To be specific, a base member 101 having a plate-like shape is prepared. The material of the base member 101 is ceramic. The base member 101 has a quadrangular shape when seen in the first negative direction X2. The dimension of each side of the base member 101 is a dimension with which the base member 101 can hold a plurality of inductor components 10. Next, a dummy insulation layer 102 is applied to the entirety of a surface of the base member 101 on the first positive direction X1 side, that is, the upper surface. In FIG. 7, the dummy insulation layer 102 is indicated by a thick line.

Next, as illustrated in FIG. 8, a first insulation-layer processing step of forming the first interlayer insulation layer 31 is performed. The first interlayer insulation layer 31 is formed on the surface of the base member 101 on the first positive direction X1 side. To be specific, patterning of the first interlayer insulation layer 31 is performed. Patterning is performed over an area that is slightly larger than an area in which the inductor conductor 50 is to be disposed. To be specific, the first interlayer insulation layer 31, including the fillers FL and the synthetic resin SR that is photocurable, is formed by photolithography. That is, the synthetic resin SR included in the first interlayer insulation layer 31 is cured by ultraviolet rays.

Next, as illustrated in FIG. 9, a seed forming step of forming the seed layer 51A is performed. To be specific, by performing sputtering, a seed portion 103 of copper is formed on surfaces of the first interlayer insulation layer 31 and the dummy insulation layer 102 on the first positive direction X1 side.

Next, as illustrated in FIG. 10, the upper surface of the seed portion 103 is laminated with a resist 104 that is photocurable. Then, only a region of the upper surface of the seed portion 103 on which the seed layer 51A of the inductor conductor 50 is to be formed is exposed to light. A portion of the resist 104 exposed to light is cured. This cured portion is formed as a covering portion 105. Subsequently, an uncured portion of the resist 104, that is, a portion other than the covering portion 105, is removed.

Next, as illustrated in FIG. 11, the seed portion 103 is etched. Thus, the seed portion 103 exposed from the covering portion 105 is removed.

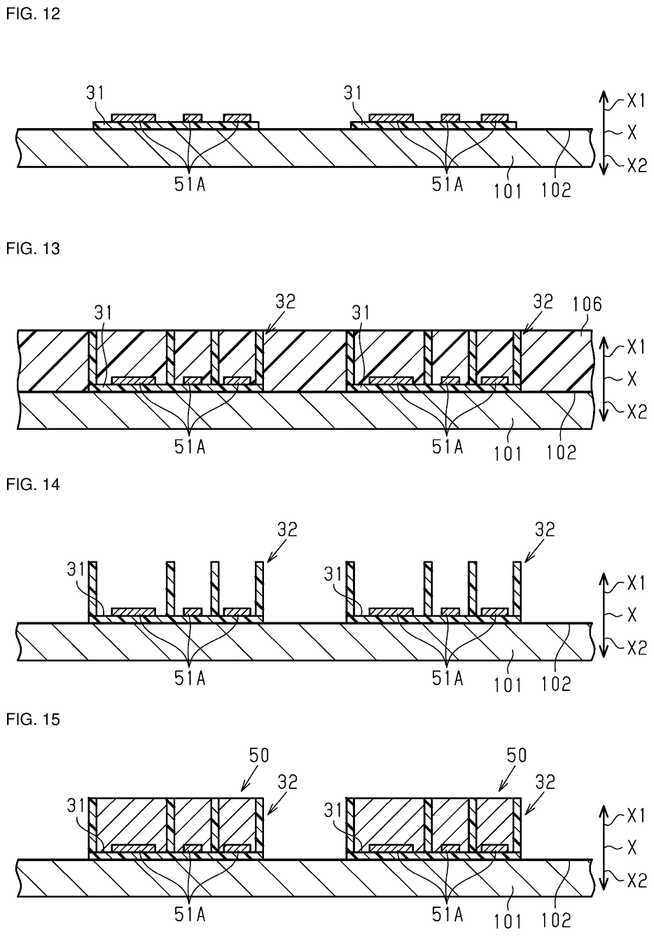

Then, as illustrated in FIG. 12, the covering portion 105 is wet-etched by using a chemical. Thus, the covering portion 105 is peeled off. As a result, the seed layer 51A is formed.

Subsequently, as illustrated in FIG. 13, a second insulation-layer processing step of forming the inter-conductor insulation layer 32 is performed. To be specific, first, surfaces of the dummy insulation layer 102, the seed layer 51A, and the first interlayer insulation layer 31 on the first positive direction X1 side are laminated with a permanent resist 106 that is photocurable. Next, a region where the inter-conductor insulation layer 32 is to be formed, that is, a region located on both sides of the seed layer 51A is exposed to light.

Next, as illustrated in FIG. 14, an uncured portion of the permanent resist 106 is peeled off and removed by using a chemical. Thus, the inter-conductor insulation layer 32 is formed. The permanent resist 106 is composed of only the synthetic resin SR.

Next, as illustrated in FIG. 15, a first conductor forming step of forming the inductor conductor 50 is performed. To be specific, by performing electrolytic copper plating, copper is grown on the surface of the first interlayer insulation layer 31 on the first positive direction X1 side from a portion where the seed layer 51A is exposed. Thus, the entirety of the inductor conductor 50 is formed. In the process in which growth of copper plating is accelerated, a surface of the inductor conductor 50 on the first positive direction X1 side may become a curved surface that is convex toward the first positive direction X1 side.

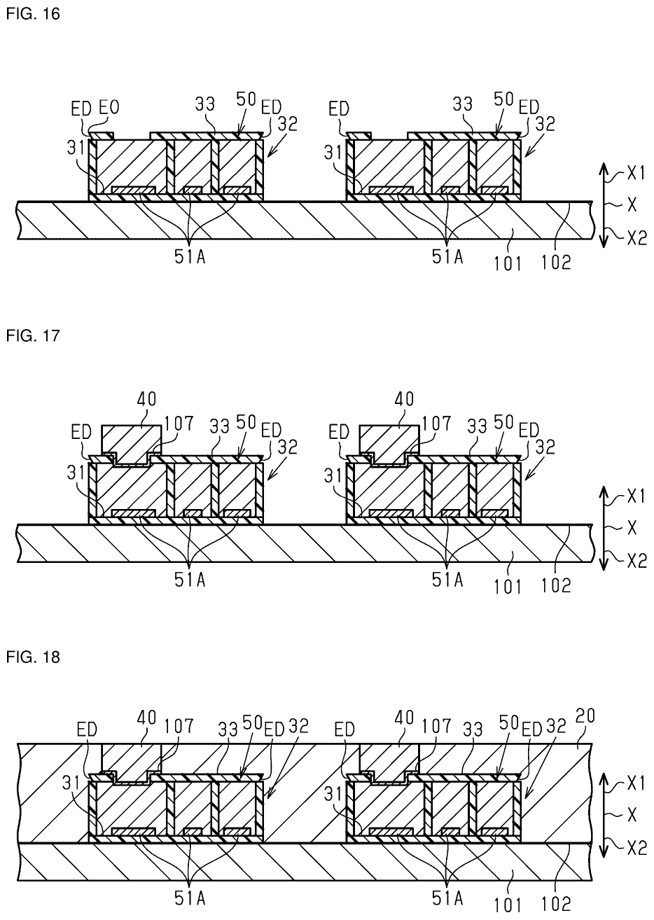

Next, as illustrated in FIG. 16, a third insulation-layer processing step of forming the second interlayer insulation layer 33 is performed. A region where the second interlayer insulation layer 33 is to be formed is a region of surfaces of the inductor conductor 50 and the inter-conductor insulation layer 32 on the first positive direction X1 side, excluding portions where the first via 41A and the second via 42A are to be formed. In this region, the second interlayer insulation layer 33 is formed by the same photolithography as that by which the first interlayer insulation layer 31 was formed. In forming the second interlayer insulation layer 33 by photolithography, the exposure value is adjusted so that the first positive direction X1 side of the second interlayer insulation layer 33 is exposed to a larger amount of light than the first negative direction X2 side. For example, the second interlayer insulation layer 33, which has not been cured, is irradiated with ultraviolet rays from the first positive direction X1 side. At this time, as ultraviolet rays propagate in the second interlayer insulation layer 33, the ultraviolet rays gradually attenuate by being blocked or scattered by the fillers FL. Thus, it is possible to adjust the exposure value as described above by performing ultraviolet-ray irradiation with an intensity such that only a very small amount of light reaches an end of the second interlayer insulation layer 33 on the first negative direction X2 side. For example, it is also possible to adjust the exposure value as described above by adjusting the irradiation angle of ultraviolet rays or the like. By adjusting the exposure value in this way, curing is accelerated more on the first positive direction X1 side than on the first negative direction X2 side, and the entirety of the end surface ED of the second interlayer insulation layer 33 is formed so as to face toward the first negative direction X2 side. Moreover, when seen in the first negative direction X2, the outermost edge EO of the end surface ED of the second interlayer insulation layer 33 coincides with the outermost edge of the inter-conductor insulation layer 32. In FIG. 16, only some of the outermost edges EO are denoted by the symbols.

Next, as illustrated in FIG. 17, a second conductor forming step of forming the columnar conductor 40 is performed. A region where the columnar conductor 40 is to be formed is a portion including a region where the inductor conductor 50 is exposed from the second interlayer insulation layer 33. First, a columnar seed layer 107 is formed in the region in the same way as in the seed forming step described above. In FIGS. 2 and 3, illustration of the columnar seed layer 107 is omitted. Then, a resist is exposed to light in a portion excluding the aforementioned region by performing photolithography in the same way as in the first insulation-layer processing step. Then, the columnar conductor 40 is formed by copper plating by performing a step similar to the first conductor forming step. Subsequently, the resist is removed. As a result, the first columnar conductor 41 and the second columnar conductor 42 are formed.

Next, as illustrated in FIG. 18, a first magnetic-body forming step of forming the magnetic layer 20 other than the first magnetic layer 21 is performed. First, a resin including magnetic powder, which is the material of the magnetic layer 20, is applied to the first positive direction X1 side with respect to the dummy insulation layer 102. At this time, the resin including magnetic powder is applied to cover also a surface of each columnar conductor 40 on the first positive direction X1 side. Next, by hardening the resin including magnetic powder by performing press working, the first interlayer magnetic layer 22, the second magnetic layer 23, the second interlayer magnetic layer 24, and the third magnetic layer 25 are formed on a surface of the dummy insulation layer 102 on the first positive direction X1 side.

Then, a portion of the third magnetic layer 25 on the first positive direction X1 side is ground until the surface of each columnar conductor 40 on the first positive direction X1 side becomes exposed. In FIG. 18, the first interlayer magnetic layer 22, the second magnetic layer 23, the second interlayer magnetic layer 24, and the third magnetic layer 25 are illustrated as the magnetic layer 20 without distinction.

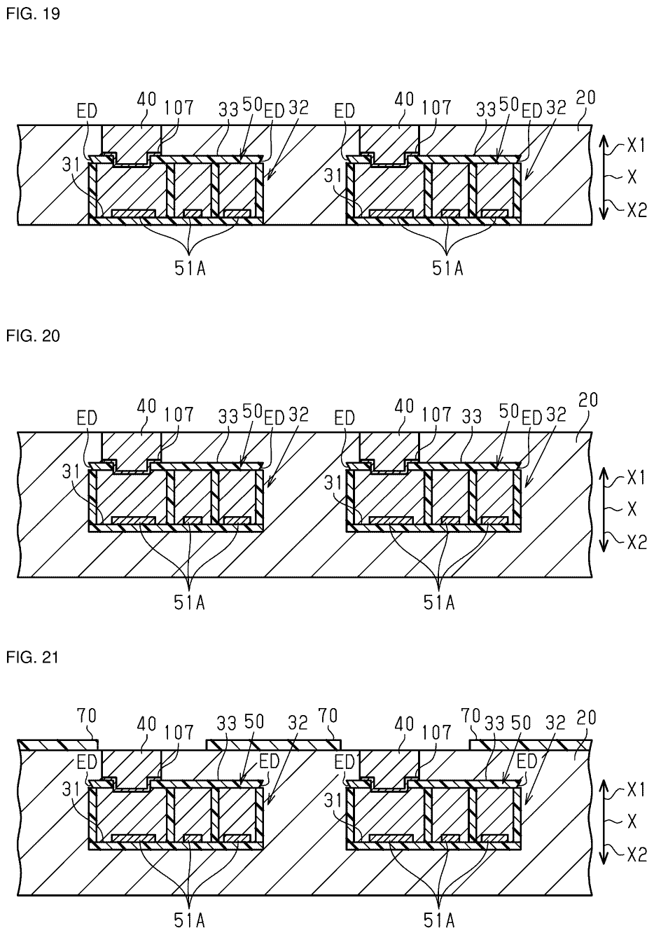

Next, as illustrated in FIG. 19, a base member cutting step is performed. To be specific, the base member 101 and the dummy insulation layer 102 are all removed by cutting. The inductor conductor 50 is not removed, although a part of the first interlayer insulation layer 31 on the first negative direction X2 side may be removed as a result of cutting of all of the base member 101 and the dummy insulation layer 102.

Next, as illustrated in FIG. 20, a second magnetic-body forming step of forming the first magnetic layer 21 is performed. To be specific, first, a resin including magnetic powder, which is the material of the first magnetic layer 21, is applied to surfaces of the first interlayer insulation layer 31 and the first interlayer magnetic layer 22 on the first negative direction X2 side. Then, the resin including magnetic powder is hardened by performing press working. Subsequently, a portion of the resin on the first negative direction X2 side is ground. For example, the portion of the resin on the first negative direction X2 side is ground so that the dimension of the inductor component 10 along the first axis X has a desired value. Thus, the first magnetic layer 21 is formed on the surfaces of the first interlayer insulation layer 31 and the first interlayer magnetic layer 22 on the first negative direction X2 side. In FIG. 20, the first magnetic layer 21, the first interlayer magnetic layer 22, the second magnetic layer 23, the second interlayer magnetic layer 24, and the third magnetic layer 25 are illustrated as the magnetic layer 20 without distinction.

Next, as illustrated in FIG. 21, a main surface processing step of forming the solder resist 70 is performed. To be specific, patterning of an insulator is performed on portions of a surface of the third magnetic layer 25 on the first positive direction X1 side and a surface of each columnar conductor 40 on the first positive direction X1 side on which each outer electrode 60 is not to be formed. Thus, the solder resist 70 is formed.

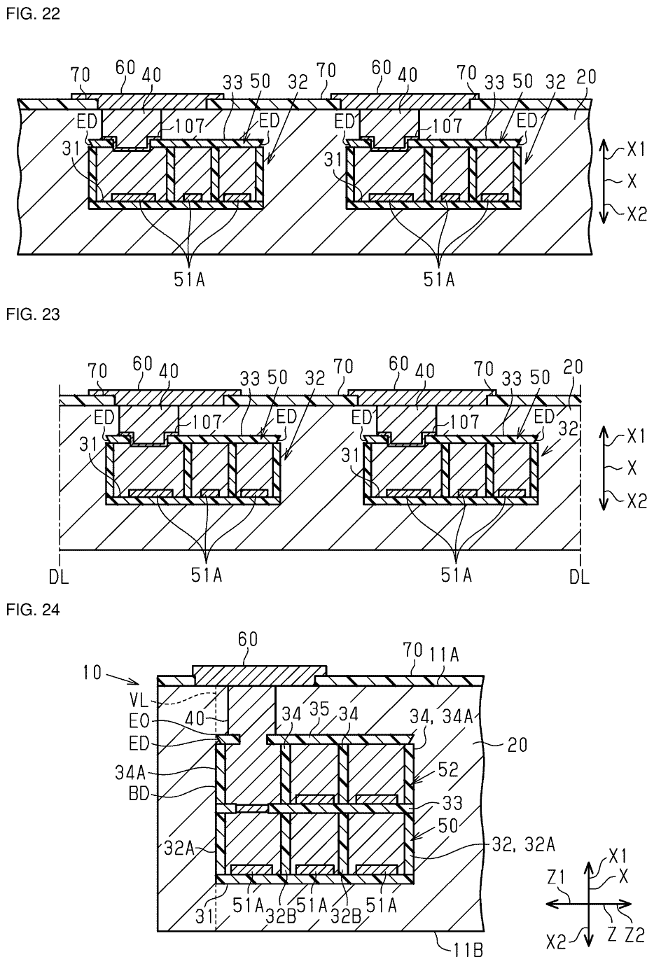

Next, as illustrated in FIG. 22, an electrode processing step of forming the outer electrode 60 is performed. A region in which the outer electrode 60 is to be formed is a region of each of a surface of the third magnetic layer 25 on the first positive direction X1 side and a surface of each columnar conductor 40 on the first positive direction X1 side that is not covered by the solder resist 70. Electroless plating of each of copper, nickel, and gold is performed on these regions. As a result, the first outer electrode 61 and the second outer electrode 62 are formed. In FIG. 22, layers of copper, nickel, and gold are illustrated without distinction. As illustrated in FIG. 22, a part of the outer electrode 60 may cover a part of a surface of the solder resist 70 on the first positive direction X1 side. Next, as illustrated in FIG. 23, a singulation step is performed. To be specific, singulation is performed by performing dicing along dividing lines DL. Thus, the inductor component 10 can be obtained.

### Advantageous Effects of Present Embodiment

(1) In the embodiment described above, the entirety of the end surface ED is an inclined surface facing in a direction parallel to the first main surface 11A and the first negative direction X2. That is, the end surface ED of the second interlayer insulation layer 33 has a shape that is recessed with respect to the outermost edge EO of a surface of the second interlayer insulation layer 33 facing in the first positive direction X1. Because the element body 11 can be present in the recessed portion of the end surface ED, the volume of the element body 11 can be increased by the volume of the recessed portion. That is, with the above configuration, in a see-through view of the inductor component 10 in a direction perpendicular to the first main surface 11A, the volume of the magnetic material can be increased compared with a case where the entirety of the end surface ED of the second interlayer insulation layer 33 is located on the boundary BD. As a result, an increase in the inductance of the inductor component 10 can be expected.
(2) In the embodiment described above, the columnar conductor 40 extends through the second interlayer insulation layer 33 in a direction intersecting the first main surface 11A and is connected to the inductor conductor 50. In other words, the distance between the second interlayer insulation layer 33, which has the end surface ED that is an inclined surface, and the columnar conductor 40 is small. When an electric current flows through the columnar conductor 40, magnetic flux may concentrate on a portion of the element body 11 in the vicinity of the columnar conductor 40, which is connected to the inductor conductor 50. Due to the aforementioned shape of the end surface ED, the magnetic material can have a sufficient volume in the portion on which magnetic flux tends to concentrate, and thus magnetic flux saturation is not likely to occur in the inductor component 10.
(3) In the embodiment described above, in a specific cross section, the outermost edge EO of the end surface ED of the second interlayer insulation layer 33 is located on the imaginary line VL that is an extension, in a direction perpendicular to the first main surface 11A, of the boundary BD between the element body 11 and the outer insulation layer 32A. That is, in a see-through view of the inductor component 10 in a direction perpendicular to the first main surface 11A, the second interlayer insulation layer 33 has a minimum size with which the second interlayer insulation layer 33 can cover the inter-conductor insulation layer 32 and the first interlayer insulation layer 31. With respect to the minimum size of the second interlayer insulation layer 33, the volume of the element body 11 can be increased further due to the aforementioned configuration of the end surface ED, and thus a proportion occupied by the element body 11 can be increased.
(4) In the embodiment described above, the second interlayer insulation layer 33 includes the synthetic resin SR that is photocurable and the plurality of fillers FL that are disposed in the synthetic resin SR. With this configuration, because light is blocked or scattered by the fillers FL when the second interlayer insulation layer 33 is being formed, curing of the synthetic resin SR is not likely to be accelerated on a side opposite from the side irradiated with light. Accordingly, because the dimension in the planar direction tends to become larger on the side on which curing is accelerated than on the side on which curing is not likely to be accelerated, this configuration is suitable for forming the end surface ED as an inclined surface.

### Modifications

The embodiment described above and modifications described below can be combined unless technical contradiction occurs.

In the embodiment described above, the inductor component 10 need not have the outer electrode 60. In this case, a portion of the columnar conductor 40 exposed from the first main surface 11A may be used as an electrode.

In the embodiment described above, each columnar conductor 40 need not extend in a direction perpendicular to the first main surface 11A, and it is sufficient that each columnar conductor 40 extend in a direction intersecting the first main surface 11A.

In the embodiment described above, the columnar conductor 40 may be located on the first negative direction X2 side with respect to the inductor conductor 50. Likewise, the outer electrode 60 may be exposed from the second main surface 11B. In other words, the mounting surface of the inductor component 10 may be the second main surface 11B.

In the embodiment described above, the shape of each columnar conductor 40 in a see-through view in a direction perpendicular to the first main surface 11A is not limited to the example in the embodiment described above. For example, all of the columnar conductors 40 may have the same shape in a see-through view in a direction perpendicular to the first main surface 11A.

In the embodiment described above, the number of turns and the shape of the inductor conductor 50 are not limited to the examples in the embodiment described above. For example, the inductor conductor 50 may have a linear shape with zero turns.

In the embodiment described above, a part of the inductor conductor 50 need not be covered with the insulation layer 30, and may be in contact with the magnetic layer 20.

In the embodiment described above, the inductor component 10 may include a plurality of inductor conductors 50. For example, let a first inductor conductor 50 be defined as the inductor conductor 50 in the embodiment described above, let a first inter-conductor insulation layer 32 be defined as the inter-conductor insulation layer 32, and let a first outer insulation layer 32A be defined as the outer insulation layer 32A. In the example illustrated in FIG. 24, the inductor component 10 further includes a second inductor conductor 52, a second inter-conductor insulation layer 34, and a third interlayer insulation layer 35. In the example illustrated in FIG. 24, the second inter-conductor insulation layer 34 extends from the second interlayer insulation layer 33 in the first positive direction X1. The second inductor conductor 52 extends on the first positive direction X1 side with respect to the second interlayer insulation layer 33 in a region partitioned by the second inter-conductor insulation layer 34. The third interlayer insulation layer 35 extends on the surfaces of the second inductor conductor 52 and the second inter-conductor insulation layer 34 on the first positive direction X1 side. That is, the second inductor conductor 52 is in contact with a surface of the third interlayer insulation layer 35 parallel to the first main surface 11A. The third interlayer insulation layer 35 is planar. The third interlayer insulation layer 35 extends parallel to the first main surface 11A. In this example, the first positive direction X1 is a direction from the second inductor conductor 52 side toward the third interlayer insulation layer 35. In the example illustrated in FIG. 24, the columnar conductor 40 is connected to the second inductor conductor 52.

In the example illustrated in FIG. 24, as with the first inter-conductor insulation layer 32, in the specific cross section, the second inter-conductor insulation layer 34 includes seven portions that are discontinuous in a direction along the first main surface 11A. In FIG. 24, four of the seven portions of the second inter-conductor insulation layer 34 are illustrated. In this respect, the first inter-conductor insulation layer 32 is illustrated in the same way. A second outer insulation layer 34A is defined as a portion of the second inter-conductor insulation layer 34, in the specific cross section, whose surface facing in a direction parallel to the first main surface 11A is in contact with the element body 11. In this example, the boundary BD between the second outer insulation layer 34A of the second inter-conductor insulation layer 34 and the element body 11 coincides with the boundary BD between the first outer insulation layer 32A of the first inter-conductor insulation layer 32 and the element body 11.

Here, an end surface ED is defined as one of the outer surfaces of the third interlayer insulation layer 35 facing in a direction parallel to the first main surface 11A. In the specific cross section, the third interlayer insulation layer 35 at one position has two end surfaces ED. The entirety of each of the end surfaces ED is an inclined surface facing in a direction parallel to the first main surface 11A and the first negative direction X2. In this example, the inclined surface is planar.

Also in the example illustrated in FIG. 24, in the specific cross section, the outermost edge EO of the end surface ED of the third interlayer insulation layer 35 is located on an imaginary line VL that is an extension, in a direction perpendicular to the first main surface 11A, of the boundary BD between the element body 11 and the second outer insulation layer 34A of the second inter-conductor insulation layer 34.

Moreover, in the example illustrated in FIG. 24, the entirety of the end surface ED, which is a surface of the second interlayer insulation layer 33 facing in a direction parallel to the first main surface 11A, may be an inclined surface facing in the direction parallel to the first main surface 11A and the first negative direction X2. In this respect, the same applies to the end surface ED of the first interlayer insulation layer 31 facing in the direction parallel to the first main surface 11A. In FIG. 24, only one of the end surfaces ED, one of the outermost edges EO, and one of the boundaries BD are denoted by symbols.

In the embodiment described above, the end surface ED is not limited to an inclined surface facing in a direction parallel to the first main surface 11A and the first negative direction X2. For example, the end surface ED may be an inclined surface the entirety of which faces in the direction parallel to the first main surface 11A and the first positive direction X1.

In the embodiment described above, the end surface ED is not limited to a planar surface. For example, the entirety of the end surface ED may be a curved surface that is convex toward the first negative direction X2 side as a whole or a curved surface that is convex toward the first positive direction X1 side. As long as the entirety of the end surface ED faces in a direction parallel to the first main surface 11A and the first negative direction X2, the curvature of the end surface ED may change in a part of the end surface ED. For example, the end surface ED may have a shape that is planar as a whole but is chamfered on the first positive direction X1 side.

In the embodiment described above, among a plurality of end surfaces ED in a specific cross section, it is sufficient that at least one of the end surfaces ED be an inclined surface facing in a direction parallel to the first main surface 11A and the first negative direction X2.

In the embodiment described above, among the outer surfaces of the first interlayer insulation layer 31, the entirety of an end surface facing in a direction parallel to the first main surface 11A may be an inclined surface. In this case, the first positive direction X1 may be defined as a direction that is one of the directions perpendicular to the first main surface 11A and that is from the inductor conductor 50 side toward the first interlayer insulation layer 31 side, and the first negative direction X2 may be defined as a direction opposite to the first positive direction X1. In this definition, the entirety of the end surface of the first interlayer insulation layer 31 may be an inclined surface facing in a direction parallel to the first main surface 11A and the first negative direction X2 or may be an inclined surface facing in a direction parallel to the first main surface 11A and the first positive direction X1. In the configuration such that the entirety of the end surface of the first interlayer insulation layer 31 is an inclined surface facing in either of the directions described above, the entirety of the end surface ED of the second interlayer insulation layer 33 may also be an inclined surface facing in either of the directions described above.

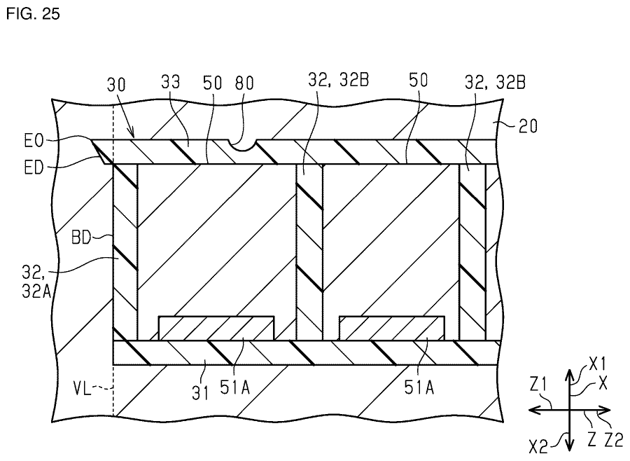

In the embodiment described above, the position of the outermost edge EO of the end surface ED is not limited to the example in the embodiment described above. For example, in a specific cross section, the outermost edge EO of the end surface ED of the second interlayer insulation layer 33 may be located on the outer insulation layer 32A side with respect to the imaginary line VL that is an extension, in a direction perpendicular to the first main surface 11A, of the boundary BD between the element body 11 and the outer insulation layer 32A. For example, in the example illustrated in FIG. 25, in a specific cross section, the outermost edge EO of the end surface ED of the second interlayer insulation layer 33 is located on the element body 11 side with respect to the imaginary line VL that is an extension, in a direction perpendicular to the first main surface 11A, of the boundary BD between the element body 11 and the outer insulation layer 32A. That is, in a see-through view in a direction perpendicular to the first main surface 11A, the outermost edge EO of the end surface ED of the second interlayer insulation layer 33 is located outside of a region surrounded by the boundary BD between the element body 11 and the outer insulation layer 32A. With this configuration, the second interlayer insulation layer 33 and the inter-conductor insulation layer 32 can be reliably connected to each other while increasing the volume of the magnetic layer 20. In the example illustrated in FIG. 25, an end of the end surface ED on the first negative direction X2 side is also located outside relative to the imaginary line VL. However, the end surface ED may be located on the imaginary line VL or inside relative to the imaginary line VL.

In the embodiment described above, in a see-through view in a direction perpendicular to the first main surface 11A, the entirety of the outermost edge EO of the end surface ED of the second interlayer insulation layer 33 need not be located in a region surrounded by the boundary BD between the element body 11 and the outer insulation layer 32A. That is, it is sufficient that there be a specific cross section in which the outermost edge EO of the end surface ED of the second interlayer insulation layer 33 is located on the imaginary line VL that is an extension, in a direction perpendicular to the first main surface 11A, of the boundary BD between the element body 11 and the outer insulation layer 32A or is located on the outer insulation layer 32A side with respect to the imaginary line VL.

In the embodiment described above, the dimension of the second interlayer insulation layer 33 along the first axis X need not be uniform. For example, in the example illustrated in FIG. 25, the second interlayer insulation layer 33 includes a recessed portion 80 in a surface thereof facing in the first positive direction X1, the recessed portion 80 being recessed in the first negative direction X2. In this example, it is possible to form the recessed portion 80 by, for example, irradiating the surface of the second interlayer insulation layer 33 facing in the first positive direction X1 with laser light in the state illustrated in FIG. 16 in the embodiment described above. The outer surface of the recessed portion 80 in this example is a curved surface. With this configuration, the volume of the magnetic material can be further increased, compared with a case where the second interlayer insulation layer 33 has a substantially uniform thickness and does not have the recessed portion 80. The recessed portion 80 may be formed in the first interlayer insulation layer 31.

In the embodiment described above, as long as the synthetic resin SR has insulating properties, the material of the synthetic resin SR is not limited to the material in the embodiment described above. It is possible to use the manufacturing method according to the embodiment described above, as long as the synthetic resin SR is photosensitive. Likewise, the material of the fillers FL is not limited to the example in the embodiment described above. For example, the material of the fillers FL may be alumina, carbon black, or the like.

In the embodiment described above, the first interlayer insulation layer 31 and the second interlayer insulation layer 33 need not include the fillers FL. That is, the first interlayer insulation layer 31 and the second interlayer insulation layer 33 may be composed of only the synthetic resin SR. The inter-conductor insulation layer 32 may include the fillers FL.

In the embodiment described above, the material of the base member 101 is not limited to the example in the embodiment described above. For example, the material of the base member 101 may be a glass epoxy resin, glass, or the like.

In the conductor forming step in the embodiment described above, a dummy conductor connected to the inductor conductor 50 may be formed. For example, it is possible to use the dummy conductor as a conductor for feeding electricity for forming copper plating.

### APPENDIX

Technical ideas that can be derived from the embodiment and the modifications described above will be described below.
[1] An inductor component comprising an element body that has a main surface and includes a magnetic material; an interlayer insulation layer that is planar and extends parallel to the main surface in the element body; and an inductor conductor that is in contact with a surface of the interlayer insulation layer parallel to the main surface. When a positive direction is defined as a direction that is one of directions perpendicular to the main surface and that is from the inductor conductor side toward the interlayer insulation layer side, a negative direction is defined as a direction opposite to the positive direction, and an end surface is defined as a surface that is one of outer surfaces of the interlayer insulation layer and that faces in a direction parallel to the main surface, in a specific cross section perpendicular to a center line of the inductor conductor, an entirety of the end surface is an inclined surface facing in a direction parallel to the main surface and the negative direction or an inclined surface facing in a direction parallel to the main surface and the positive direction.
[2] The inductor component according to [1], further comprising a columnar conductor that extends through the interlayer insulation layer in a direction intersecting the main surface and that is connected to the inductor conductor.
[3] The inductor component according to [1] or [2], wherein the interlayer insulation layer includes a recessed portion in a surface thereof facing in the positive direction, the recessed portion being recessed in the negative direction.
[4] The inductor component according to any one of [1] to [3], further comprising an inter-conductor insulation layer that extends from the interlayer insulation layer in a direction perpendicular to the main surface and that includes a portion adjacent to the inductor conductor in a direction parallel to the main surface. In the specific cross section, the inter-conductor insulation layer includes a plurality of portions that are discontinuous in a direction along the main surface. Also, when an outer insulation layer is defined as a portion that is one of the plurality of portions of the inter-conductor insulation layer and whose surface facing in a direction parallel to the main surface is in contact with the element body, in the specific cross section, an outermost edge of the end surface of the interlayer insulation layer is located on an imaginary line that is an extension, in a direction perpendicular to the main surface, of a boundary between the element body and the outer insulation layer or is located on the outer insulation layer side with respect to the imaginary line.
[5] The inductor component according to any one of [1] to [4], wherein the interlayer insulation layer includes a synthetic resin that is photocurable and a plurality of fillers that are dispersed in the synthetic resin.

What is claimed is:

1. An inductor component comprising:
an element body that has a main surface and includes a magnetic material;
an interlayer insulation layer that is planar and extends parallel to the main surface in the element body; and
an inductor conductor that is in contact with a surface of the interlayer insulation layer parallel to the main surface,
wherein, when a positive direction is defined as a direction that is one of directions perpendicular to the main surface and that is from the inductor conductor side toward the interlayer insulation layer side, a negative direction is defined as a direction opposite to the positive direction, and an end surface is defined as a surface that is one of outer surfaces of the interlayer insulation layer and that faces in a direction parallel to the main surface,
in a specific cross section perpendicular to a center line of the inductor conductor, an entirety of the end surface is an inclined surface facing in a direction parallel to the main surface and the negative direction or an inclined surface facing in a direction parallel to the main surface and the positive direction.

2. The inductor component according to claim 1, further comprising:
a columnar conductor that extends through the interlayer insulation layer in a direction intersecting the main surface and that is connected to the inductor conductor.

3. The inductor component according to claim 1, wherein
the interlayer insulation layer includes a recessed portion in a surface thereof facing in the positive direction, the recessed portion being recessed in the negative direction.

4. The inductor component according to claim 1, further comprising:
an inter-conductor insulation layer that extends from the interlayer insulation layer in a direction perpendicular to the main surface and that includes a portion adjacent to the inductor conductor in a direction parallel to the main surface,
wherein
in the specific cross section, the inter-conductor insulation layer includes a plurality of portions that are discontinuous in a direction along the main surface, and
when an outer insulation layer is defined as a portion that is one of the plurality of portions of the inter-conductor insulation layer and whose surface facing in a direction parallel to the main surface is in contact with the element body,
in the specific cross section, an outermost edge of the end surface of the interlayer insulation layer is located on an imaginary line that is an extension, in a direction perpendicular to the main surface, of a boundary between the element body and the outer insulation layer or is located on the outer insulation layer side with respect to the imaginary line.

5. The inductor component according to claim 1, wherein
the interlayer insulation layer includes a synthetic resin that is photocurable and a plurality of fillers that are dispersed in the synthetic resin.

6. The inductor component according to claim 2, wherein
the interlayer insulation layer includes a recessed portion in a surface thereof facing in the positive direction, the recessed portion being recessed in the negative direction.

7. The inductor component according to claim 2, further comprising:
an inter-conductor insulation layer that extends from the interlayer insulation layer in a direction perpendicular to the main surface and that includes a portion adjacent to the inductor conductor in a direction parallel to the main surface,
wherein
in the specific cross section, the inter-conductor insulation layer includes a plurality of portions that are discontinuous in a direction along the main surface, and
when an outer insulation layer is defined as a portion that is one of the plurality of portions of the inter-conductor insulation layer and whose surface facing in a direction parallel to the main surface is in contact with the element body,
in the specific cross section, an outermost edge of the end surface of the interlayer insulation layer is located on an imaginary line that is an extension, in a direction perpendicular to the main surface, of a boundary between the element body and the outer insulation layer or is located on the outer insulation layer side with respect to the imaginary line.

8. The inductor component according to claim 3, further comprising:
an inter-conductor insulation layer that extends from the interlayer insulation layer in a direction perpendicular to the main surface and that includes a portion adjacent to the inductor conductor in a direction parallel to the main surface,
wherein
in the specific cross section, the inter-conductor insulation layer includes a plurality of portions that are discontinuous in a direction along the main surface, and
when an outer insulation layer is defined as a portion that is one of the plurality of portions of the inter-conductor insulation layer and whose surface facing in a direction parallel to the main surface is in contact with the element body,
in the specific cross section, an outermost edge of the end surface of the interlayer insulation layer is located on an imaginary line that is an extension, in a direction perpendicular to the main surface, of a boundary between the element body and the outer insulation layer or is located on the outer insulation layer side with respect to the imaginary line.

9. The inductor component according to claim 6, further comprising:
an inter-conductor insulation layer that extends from the interlayer insulation layer in a direction perpendicular to the main surface and that includes a portion adjacent to the inductor conductor in a direction parallel to the main surface,
wherein
in the specific cross section, the inter-conductor insulation layer includes a plurality of portions that are discontinuous in a direction along the main surface, and
when an outer insulation layer is defined as a portion that is one of the plurality of portions of the inter-conductor insulation layer and whose surface facing in a direction parallel to the main surface is in contact with the element body,
in the specific cross section, an outermost edge of the end surface of the interlayer insulation layer is located on an imaginary line that is an extension, in a direction perpendicular to the main surface, of a boundary between the element body and the outer insulation layer or is located on the outer insulation layer side with respect to the imaginary line.

10. The inductor component according to claim 2, wherein
the interlayer insulation layer includes a synthetic resin that is photocurable and a plurality of fillers that are dispersed in the synthetic resin.

11. The inductor component according to claim 3, wherein
the interlayer insulation layer includes a synthetic resin that is photocurable and a plurality of fillers that are dispersed in the synthetic resin.

12. The inductor component according to claim 4, wherein
the interlayer insulation layer includes a synthetic resin that is photocurable and a plurality of fillers that are dispersed in the synthetic resin.

13. The inductor component according to claim 6, wherein
the interlayer insulation layer includes a synthetic resin that is photocurable and a plurality of fillers that are dispersed in the synthetic resin.

14. The inductor component according to claim 7, wherein
the interlayer insulation layer includes a synthetic resin that is photocurable and a plurality of fillers that are dispersed in the synthetic resin.

15. The inductor component according to claim 8, wherein
the interlayer insulation layer includes a synthetic resin that is photocurable and a plurality of fillers that are dispersed in the synthetic resin.

16. The inductor component according to claim 9, wherein
the interlayer insulation layer includes a synthetic resin that is photocurable and a plurality of fillers that are dispersed in the synthetic resin.
